(19) United States
(12) Patent Application Publication
(10) Pub. No.: US 2011/0169724 A1
(43) Pub. Date: Jul. 14, 2011

(54) INTERFEROMETRIC PIXEL WITH PATTERNED MECHANICAL LAYER

(75) Inventors: Yi Tao, San Jose, CA (US); Fan Zhong, Fremont, CA (US); Yeh-Jiun Tung, Sunnyvale, CA (US)

(73) Assignee: QUALCOMM MEMS Technologies, Inc., San Diego, CA (US)

(21) Appl. No.: 12/684,769

(22) Filed: Jan. 8, 2010

(51) Int. Cl. G09G 3/34; G02B 26/00; H01J 9/00

(52) U.S. Cl. 345/108; 359/291; 445/1

(57) ABSTRACT

Interferometric modulators and methods of making the same are disclosed. In one embodiment, an interferometric display includes a sub-pixel having a membrane layer with a void formed therein. The void can be configured to increase the flexibility of the membrane layer. The sub-pixel can further include an optical mask configured to hide the void from a viewer. In another embodiment, an interferometric display can include at least two movable reflectors wherein each movable reflector has a different stiffness but each movable reflector has substantially the same effective coefficient of thermal expansion.

### BACKGROUND

1. Field

The field of invention relates to electromechanical systems.

2. Description of the Related Art

Electromechanical systems include devices having electrical and mechanical elements, actuators, transducers, sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers or that add layers to form electrical and electromechanical devices.

One type of electromechanical systems device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by a gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments,” one will understand how the features of this invention provide advantages over other display devices.

Various embodiments described herein comprise an interferometric pixel including a plurality of sub-pixels. Each sub-pixel includes a movable layer that is movable with respect to an absorber layer, and an optical resonant cavity disposed between the absorber layer and the movable layer.

In one embodiment, an interferometric display comprises a substrate having a coefficient of thermal expansion characteristic, an optical mask disposed on the substrate, an absorber disposed on the substrate, a first sub-pixel, and a second sub-pixel. The first sub-pixel can include a first movable reflector configured to move in a direction substantially perpendicular to the substrate between an unactuated position and an actuated position when a voltage is applied to the first movable reflector. The first movable reflector can have an effective coefficient of thermal expansion characteristic that is substantially the same as the coefficient of thermal expansion characteristic of the substrate and the first movable reflector can include a first reflective layer, a first conductive layer, and a first membrane layer disposed at least partially between the first reflective layer and the first conductive layer. The first sub-pixel can also include a first electrode configured to apply a voltage to the first movable reflector and a first cavity defined by a surface of the first movable reflector and a surface of the absorber. The second sub-pixel can include a second movable reflector configured to move in a direction substantially perpendicular to the substrate between an unactuated position and an actuated position when a voltage is applied to the second movable reflector, the second movable reflector having an effective coefficient of thermal expansion characteristic that is substantially the same as the coefficient of thermal expansion characteristic of the substrate, a second electrode configured to apply a voltage to the second movable reflector, and a second cavity defined by a surface of the second movable reflector and a surface of the absorber. The second movable reflector can include a second reflective layer, a second conductive layer, and a second membrane layer disposed at least partially between the second reflective layer and the second conductive layer, the second membrane layer comprising at least one void, wherein the void is configured to increase the flexibility of the second membrane layer, wherein at least a portion of the optical mask is disposed between the at least one void and the substrate.

In one aspect, at least one edge of the second membrane layer surrounding the at least one void is at least partially curvilinear. In another aspect, a surface of the second membrane layer surrounding the void is columnar. According to one aspect, at least a portion of the optical mask is disposed between the first membrane layer and the substrate and the first movable reflector and the second movable reflector are disposed adjacent to one another. In another aspect, the coefficient of thermal expansion of the substrate is about 3.7 ppm/° C. In yet another aspect, the second reflective layer comprises at least one void and a portion of the optical mask is disposed between the void and the substrate. In one aspect, the at least one void in the second reflective layer is generally aligned with the at least one void in the second membrane layer. In another aspect, the second conductive layer comprises at least one void that is generally aligned with at least one void in the second reflective layer.

In another embodiment, a pixel includes a substrate layer having a coefficient of thermal expansion characteristic, an absorber disposed on the substrate, a first sub-pixel, and a second sub-pixel. The first sub-pixel can include a first movable reflector configured to move in a direction substantially perpendicular to the absorber between an unactuated position and an actuated position when a voltage is applied to the first movable reflector, the first movable reflector having an effective coefficient of thermal expansion characteristic that is substantially the same as the coefficient of thermal expansion characteristic of the substrate, a first electrode configured to apply a voltage to the first movable reflector to move the first movable reflector from the unactuated position to the actuated position, and a first cavity defined by a surface of the first movable reflector and a surface of the absorber, the first cavity having a height dimension defined by the distance between the first movable reflector and the absorber when the first movable reflector is in the unactuated position. The first movable reflector can comprise a first reflective layer, a first conductive layer, and a first membrane layer disposed at least partially between the first reflective layer and the first conductive layer, the first membrane layer having a thickness dimension defined by the distance between the first reflective layer and the first conductive layer. The second sub-pixel can include a second movable reflector configured to move in a direction substantially perpendicular to the substrate between an unactuated position and an actuated position when a voltage is applied to the second movable reflector, the second movable reflector having an effective coefficient of thermal expansion characteristic that is substantially the same as the coefficient of thermal expansion characteristic of the substrate, a second electrode configured to apply a voltage to the second movable reflector, the voltage applied by the second electrode being substantially the same as the voltage applied by the first electrode, and a second cavity defined by a surface of the second movable reflector and a surface of the absorber, the second cavity having a height dimension defined by the distance between the second movable reflector and the absorber when the second movable reflector is in the unactuated position, the height dimension of the second cavity being greater than the height dimension of the first cavity. The second movable reflector can comprise a second reflective layer, a second conductive layer, and a second membrane layer disposed at least partially between the second reflective layer and the second conductive layer, the second membrane layer having a thickness dimension defined by the distance between the second reflective layer and the second conductive layer, the thickness dimension of the second membrane layer being substantially the same as the thickness dimension of the first membrane layer, the second membrane layer comprising at least one void; wherein the void is configured to increase the flexibility of the second membrane layer such that the second movable reflector moves a greater distance than the first movable reflector when an equal voltage is applied to the first movable reflector and the second movable reflector.

In one aspect, the first cavity and/or second cavity can comprise an optically resonant material, for example, air. In another aspect, the pixel is an interferometric pixel. In another aspect, the coefficient of thermal expansion characteristic of the substrate layer is about 3.7 ppm/° C. In yet another aspect, the first and/or second membrane layers comprise a dielectric material, for example, silicon oxy-nitride. In one aspect, the first conductive layer, first reflective layer, second conductive layer, and/or second reflective layer comprises aluminum. In one aspect, the thickness of the first membrane layer is about 1600 Å. In another aspect, the first membrane layer comprises a void that is smaller than the void in the second membrane layer. In one aspect, the pixel further comprises an optical mask disposed between at least a portion of the second sub-pixel and the substrate and at least a portion of the optical mask can be disposed between the at least one void and the substrate and/or between at least a portion of the first sub-pixel and the substrate. The first sub-pixel can be disposed adjacent to the second sub-pixel.

In yet another aspect, the pixel further comprises a display, a processor that is configured to communicate with the display, the processor being configured to process image data, and a memory device that is configured to communicate with the processor. In one aspect, the pixel further comprises a driver circuit configured to send at least one signal to the display and can comprise a controller configured to send at least a portion of the image data to the driver circuit. In another aspect, the pixel further comprises an image source module configured to send the image data to the processor and the image source module can comprise at least one of a receiver, transceiver, and transmitter. In another aspect, the pixel further comprises an input device configured to receive input data and to communicate the input data to the processor.

In another embodiment, a pixel for use in a reflective display comprises a substrate layer having a coefficient of thermal expansion characteristic, an absorber layer disposed on the substrate layer, and a plurality of sub-pixels, each sub-pixel comprises a movable reflector configured to move relative to the absorber layer, each movable reflector comprising a reflective layer having a first thickness, a conductive layer having a second thickness, and a membrane layer disposed at least partially between the reflective layer and the conductive layer, the membrane layer having a third thickness, wherein each movable reflector is configured to move between an unactuated position and an actuated position when a voltage value is applied to the sub-pixel, wherein the same voltage value is applied to each movable reflector independently, wherein a first sub-pixel has a first membrane layer that is more flexible than a second membrane layer in a second sub-pixel such that the first membrane layer moves a greater distance than the second membrane layer when the voltage value is applied, and wherein each movable reflector has an effective coefficient of thermal expansion characteristic that is substantially the same as the coefficient of thermal expansion characteristic of the substrate layer.

In one aspect, the third thickness is greater than the first and second thicknesses. In another aspect, the first and second thicknesses are substantially the same. In yet another aspect, the at least one membrane comprises a void. In another aspect, the pixel further comprises a plurality of electrodes that are configured to apply the voltage value to a movable reflector.

In another embodiment, an interferometric pixel comprises a substrate having a coefficient of thermal expansion characteristic, an optical mask means disposed on the substrate, an absorber means for absorbing certain wavelengths of electromagnetic radiation, the absorber means disposed on the substrate, a first sub-pixel means, and a second sub-pixel means. The first sub-pixel means can comprise a first movable reflector means configured to move in a direction substantially perpendicular to the substrate between an unactuated position and an actuated position when a voltage is applied to the first movable reflector means, the first movable reflector means having an effective coefficient of thermal expansion characteristic that is substantially the same as the coefficient of thermal expansion characteristic of the substrate, a first voltage applying means configured to apply a voltage value to the first movable reflector means, and a first cavity defined by a surface of the first movable reflector means and a surface of the absorber means. The first movable reflector means can comprise a first reflective means, a first conductive means, and a first membrane means disposed at least partially between the first reflective means and the first conductive means. The second sub-pixel means can include a second movable reflector means configured to move in a direction substantially perpendicular to the substrate between an unactuated position and an actuated position when a voltage is applied to the second movable reflector means, the second movable reflector means having an effective coefficient of thermal expansion characteristic that is substantially the same as the coefficient of thermal expansion coefficient of the substrate, a second voltage applying means configured to apply a voltage value to the second movable reflector means, and a second cavity defined by a surface of the second movable reflector means and a surface of the absorber means. The second movable reflector means can include a second reflective means, a second conductive means, and a second membrane means disposed at least partially between the second reflective means and the second conductive means, the second membrane means comprising at least one void, wherein the void is configured to increase the flexibility of the second membrane means, wherein at least a portion of the optical mask means is disposed between the at least one void and the substrate.

In another embodiment, a method of manufacturing an interferometric pixel comprises providing a substrate, forming an optical mask on the substrate, forming a first movable structure over the substrate, the first movable structure being separated from the substrate by a first distance, the first movable structure comprising a first reflective layer, a first conductive layer, and a first membrane layer disposed between the first reflective layer and the first conductive layer, the first membrane layer having a thickness dimension defined by the distance between the first reflective layer and the first conductive layer, forming a second movable structure over the substrate, the second movable structure being separated from the substrate by a second distance, the second distance being greater than the first distance, the second movable structure comprising a second reflective layer, a second conductive layer, and a second membrane layer disposed between the second reflective layer and the second conductive layer, the second membrane having a thickness dimension defined by the distance between the second reflective layer and the second conductive layer, the thickness dimension of the second membrane layer being substantially the same as the thickness of the first membrane layer, and forming at least one void in the second movable structure such that optical mask is positioned between the at least one void and the substrate. In one aspect, the optical mask is positioned between at least a portion of the first movable structure and the substrate.

In another embodiment, a method of manufacturing an interferometric pixel comprises providing a substrate having a coefficient of thermal expansion characteristic, forming an optical mask on the substrate, and forming a first movable structure over the substrate, the first movable structure being separated from the substrate by a first distance, the first movable structure comprising a first reflective layer having a thickness dimension, a first conductive layer having a thickness dimension, and a first membrane layer disposed between the first reflective layer and the first conductive layer, the first membrane layer having a thickness dimension defined by the distance between the first reflective layer and the first conductive layer, the first movable structure having an effective coefficient of thermal expansion characteristic, wherein the thickness dimension of the first reflective layer, the thickness dimension of the first conductive layer, and the thickness dimension of the first membrane layer are all selected such that the effective coefficient of thermal expansion characteristic of the first movable structure is substantially the same as the coefficient of thermal expansion characteristic of the substrate. In one aspect, the method further includes forming a second movable structure over the substrate, the second movable structure being separated from the substrate by a second distance, the second distance being greater than the first distance, the second movable structure comprising a second reflective layer having a thickness dimension, a second conductive layer having a thickness dimension, and a second membrane layer disposed between the second reflective layer and the second conductive layer, the second membrane layer having a thickness dimension defined by the distance between the second reflective layer and the second conductive layer, the second movable structure having an effective coefficient of thermal expansion characteristic, wherein the thickness dimension of the second reflective layer, the thickness dimension of the second conductive layer, and the thickness dimension of the second membrane layer are all selected such that the effective coefficient of thermal expansion characteristic of the second movable structure is substantially the same as the coefficient of thermal expansion characteristic of the substrate, and forming at least one void in the second movable structure such that the optical mask is positioned in between the at least one void and the substrate.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross-section of the device of FIG. 1.

FIG. 7B is a cross-section of an alternative embodiment of an interferometric modulator.

FIG. 7C is a cross-section of another alternative embodiment of an interferometric modulator.

FIG. 7D is a cross-section of yet another alternative embodiment of an interferometric modulator.

FIG. 7E is a cross-section of an additional alternative embodiment of an interferometric modulator.

FIG. 8A is a cross-section of an embodiment of a movable element.

FIG. 8B is a cross-section of another embodiment of a movable element.

FIG. 9A is a top plan view depicting a portion of one embodiment of an interferometric display.

FIG. 9B is a cross-section of the display of FIG. 9A, taken along line 9B-9B of FIG. 9A.

FIGS. 10A-10F are schematic cross-sectional views illustrating steps in a process of manufacturing an interferometric display.

FIG. 11 is a flow diagram illustrating certain steps in an embodiment of a method of making an interferometric display.

FIG. 12 is a flow diagram illustrating certain steps in another embodiment of a method of making an interferometric display.

FIG. 13A is a top view of an embodiment of a movable element that includes a void disposed in a corner of the movable element under an optical mask.

FIG. 13B is a top view of an embodiment of a movable element that includes a void disposed in a corner of the movable element under an optical mask.

FIG. 13C is a top view of an embodiment of a movable element that includes a void disposed in a corner of the movable element under an optical mask.

FIG. 13D is a top view of an embodiment of a movable element that includes a void disposed in a corner of the movable element under an optical mask.

FIG. 13E is a top view of an embodiment of a movable element that does not include a void.

### DETAILED DESCRIPTION OF CERTAIN EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Reflective display devices, for example, interferometric modulator display devices, can include one or more pixels which can have one or more sub-pixels. Each pixel, or sub-pixel can include a movable element configured to move with respect to a light absorbing layer, which may be referred to herein simply as an “absorber.” Each pixel, or sub-pixel, can also include an optical resonant cavity disposed between the movable element and the absorber. The movable element, absorber, and optical resonant cavity can be configured to selectively absorb and/or reflect light incident thereon using principles of optical interference. The movable element can be moved between two or more positions, which changes the size of the optical resonant cavity and affects the reflectance of the sub-pixel and correspondingly, the display. In some embodiments, the movable element includes a reflective layer, a conductive layer, and an insulating membrane layer disposed between the reflective layer and the conductive layer. In embodiments of a display device having more than one pixel or sub-pixel, each movable element can have an effective coefficient of thermal expansion characteristic. When making the movable element, the movable elements can be adjusted such that each movable element has about the same effective coefficient of thermal expansion and about the same thickness, but the stiffness of each movable element can be configured to vary from one movable element to another.

Adjusting (or tuning) the thickness, effective coefficient of thermal expansion, and stiffness of the movable elements can reduce the temperature sensitivity of the display and reduce the number of masks required in manufacturing without requiring an increased actuation voltage for system operation. In some embodiments, the effective coefficient of thermal expansion of a movable element can be selected by adjusting the ratio of the membrane layer thickness to the combined thickness of the reflective and conductive layers. The effective coefficients of thermal expansion of the movable elements can be adjusted to substantially match the coefficient of thermal expansion of a substrate layer. The stiffness of a movable element can be adjusted by adding one or more voids through the reflective layer, membrane layer, and conductive layer. By tuning both the effective coefficients of thermal expansion and the stiffness of multiple movable elements, the movable elements can each be configured to have substantially the same effective coefficients of thermal expansion and substantially the same thicknesses while having a different stiffness.

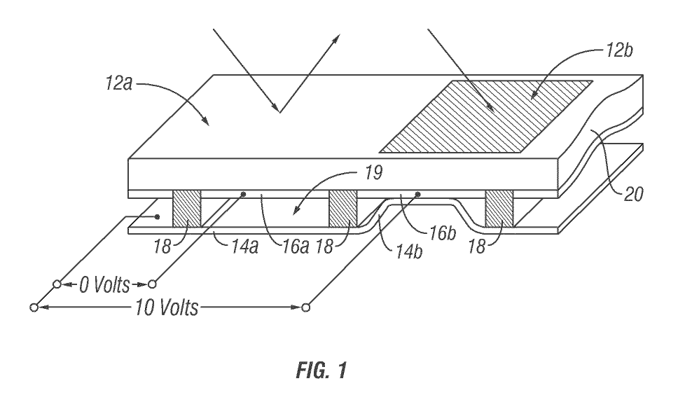

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, the illustrated two pixels could each be a sub-pixel, where two or more sub-pixels would make up a pixel. One of skill in the art will appreciate that the description of pixels herein may also be relevant for sub-pixels. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (e.g., orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

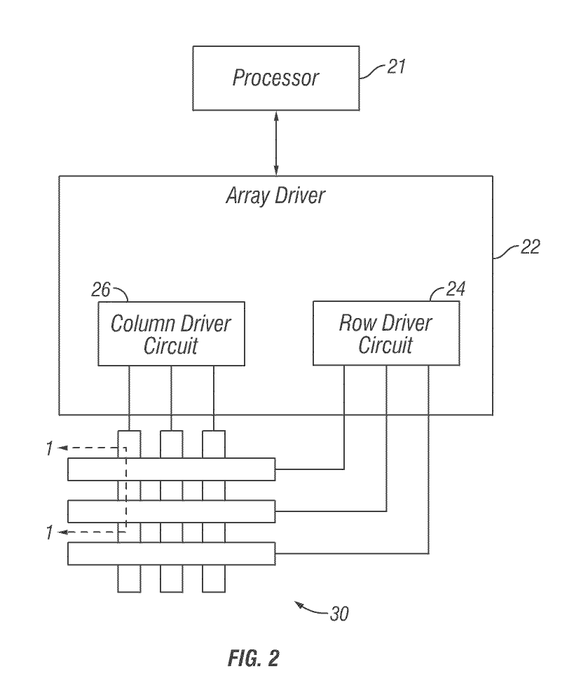

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor, for example, an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

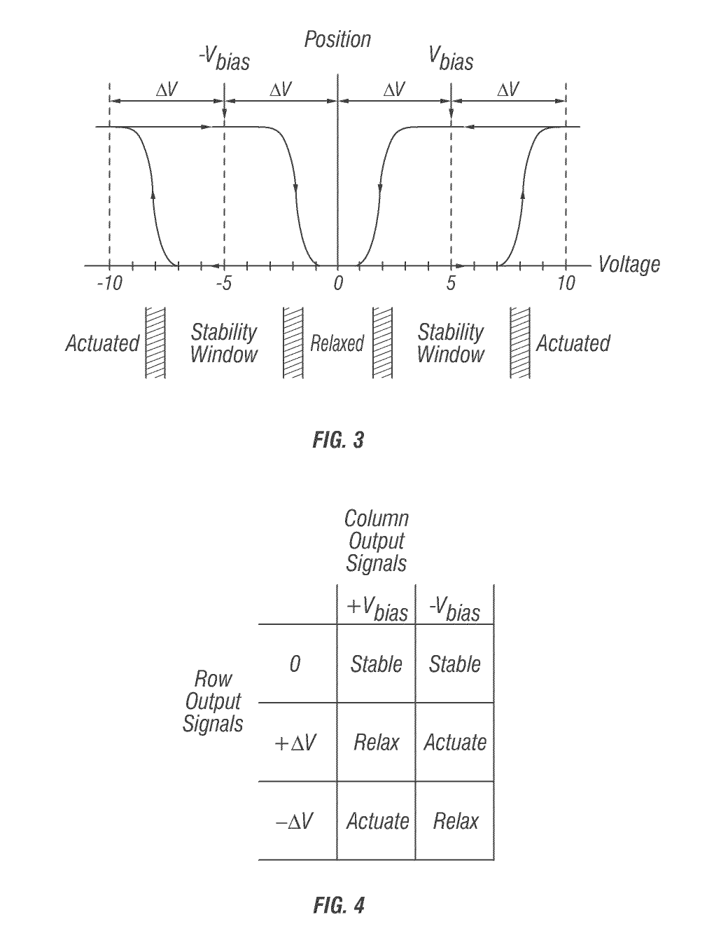

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

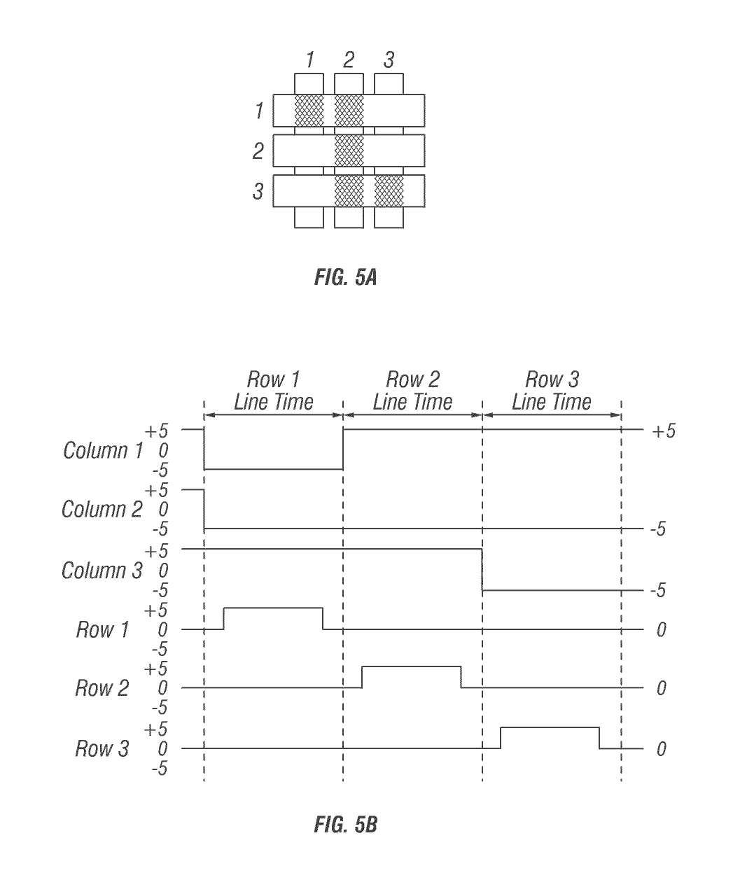

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

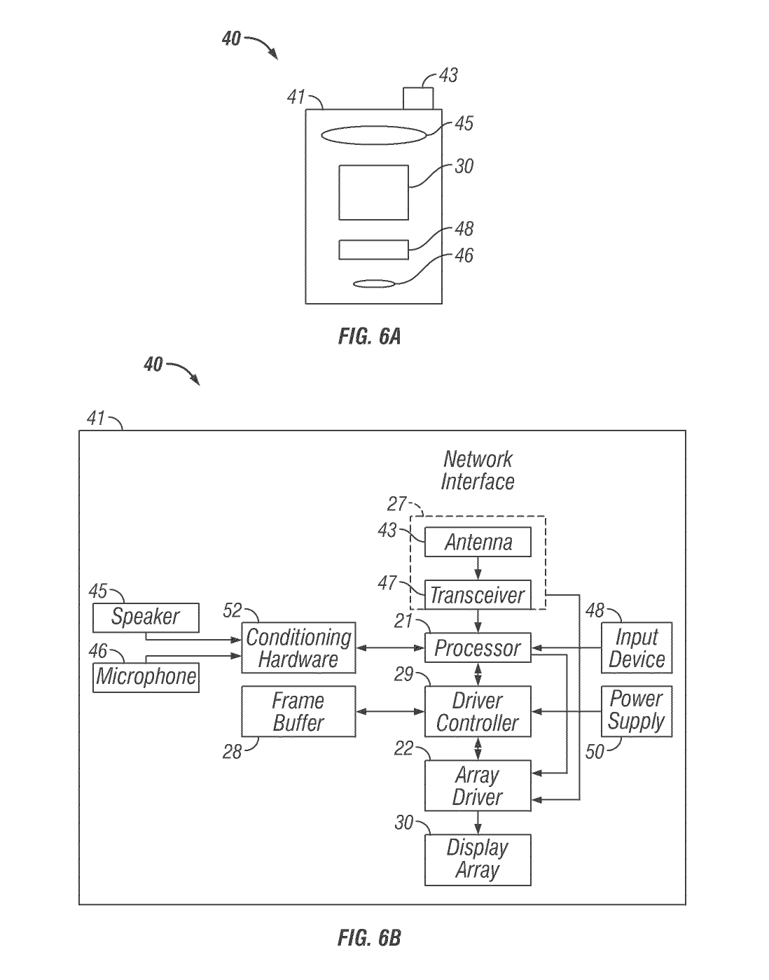

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device,. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

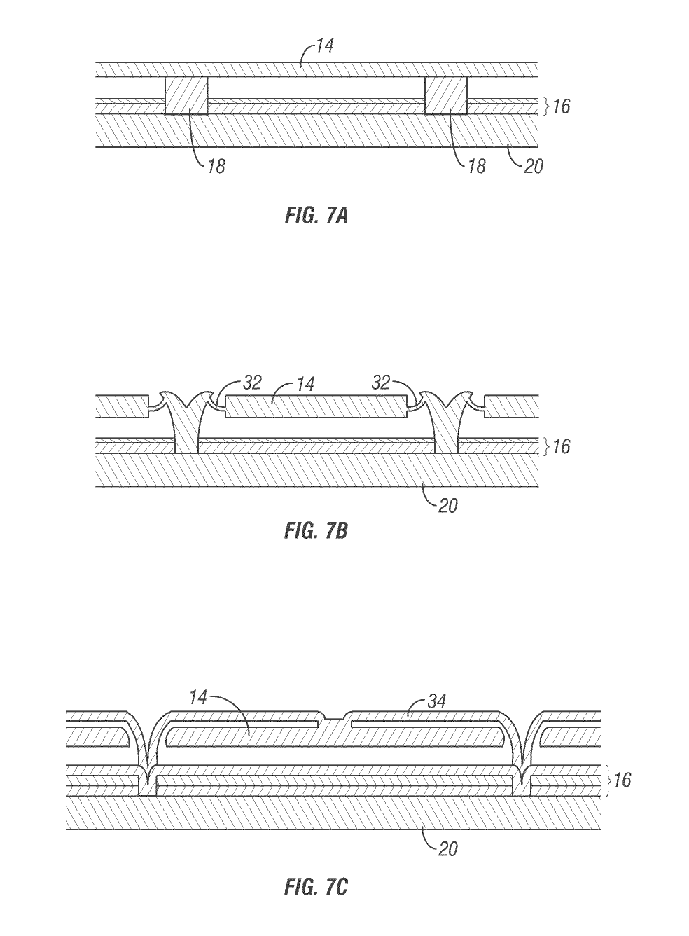

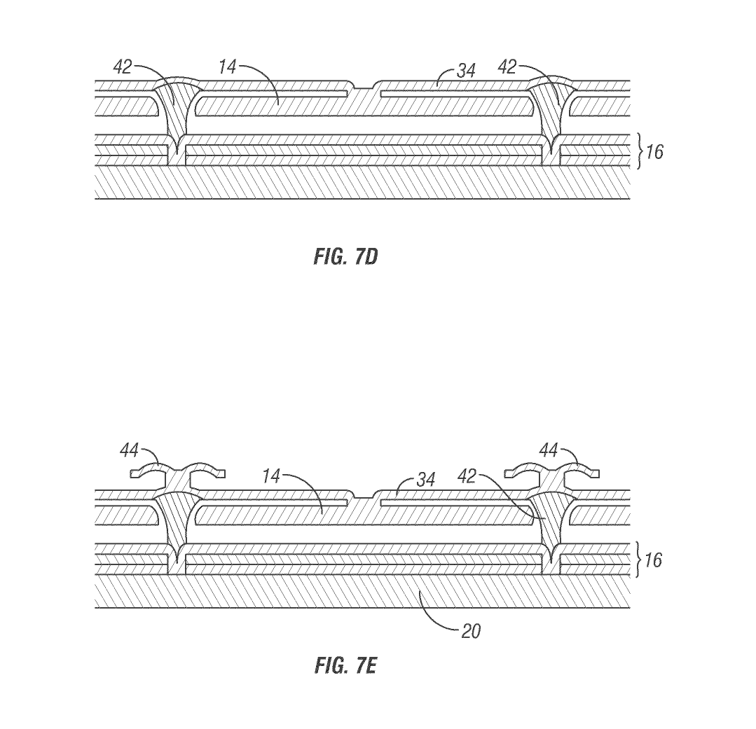

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

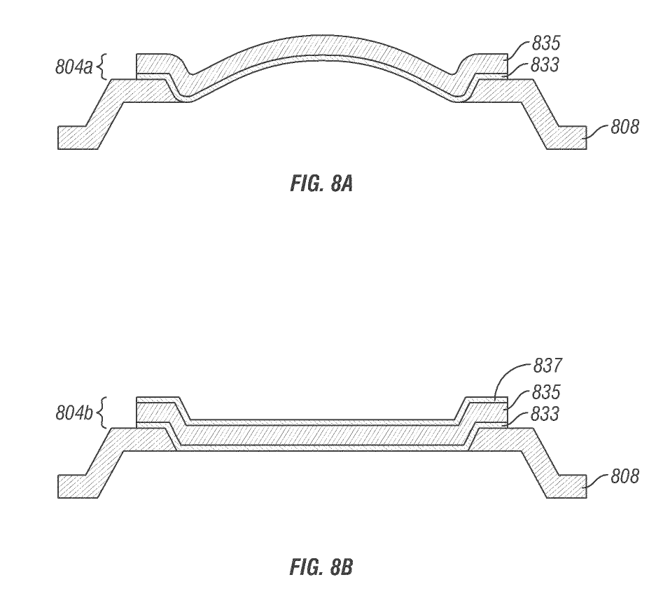

FIG. 8A illustrates an embodiment of a movable element 804a. Movable element 804a can be configured to move relative to an absorber layer as part of an interferometric display to selectively absorb and/or reflect light incident thereon. An absorber layer (not shown) can support the movable element 804a by one or more supports 808. In the embodiment illustrated in FIG. 8A, the movable element 804a includes a reflective layer 833 and a membrane layer 835 disposed on the reflective layer. Due to differences in, for example, materials, configuration, or manufacturing, the membrane layer 835 and the reflective layer 833 can have different residual stresses. For example, the membrane layer 835 can have a residual stress of about 100 MPa and the reflective layer 833 can have a residual stress of about 300 MPa. The difference in residual stresses between the membrane layer 835 and the reflective layer 833 can cause the movable element 804a to curve, bend, deflect, or otherwise change shape as illustrated in FIG. 8A. In some embodiments, the movable element 804a may curve such that the center of the movable element 804a is displaced by about 200 nm from its uncurved position. The movable element 804a may also curve or bend due to changes in temperature and the corresponding expansion and contraction of the membrane 835 and reflective 833 layers.

FIG. 8B illustrates another embodiment of a movable element 804b. The movable element 804b can include a reflective layer 833, a conductive layer 837, and a membrane layer 835 disposed between the reflective layer and the conductive layer. In some embodiments, the conductive layer 837 can be configured to balance the difference in residual stress between the reflective layer 833 and the membrane layer 835. For example, the conductive layer 837 can be incorporated into a movable element 804b to limit the curving of the movable element due to residual and/or temperature related stresses.

The reflective layer 833 can comprise any reflective or partially reflective material. For example, the reflective layer 833 can comprise various metals including aluminum, copper, silver, molybdenum, gold, chromium, and/or alloys. In some embodiments, the reflective layer 833 comprises a conductive material. The reflective layer 833 can be characterized by a coefficient of thermal expansion characteristic. As used herein, “coefficient of thermal expansion” means the three-dimensional response to temperature change for a given material. In one embodiment, the reflective layer 833 is aluminum and has a coefficient of thermal expansion of about 24 ppm/C. The membrane layer 835 can comprise various dielectric or insulating materials, for example, silicon oxy-nitride. In some embodiments, the membrane layer 835 comprises a plurality of layers each comprising a dielectric material. The membrane layer 835 can be characterized by a coefficient of thermal expansion characteristic. In one embodiment, the membrane layer 835 is silicon oxy-nitride and has a coefficient of thermal expansion of about 2.6 ppm/C. The conductive layer 837 can comprise any conductive material, for example, aluminum, copper, and/or other metals. In some embodiments, the conductive layer 837 comprises the same material as the reflective layer 833. The conductive layer 837 can be characterized by a coefficient of thermal expansion. In one embodiment, the conductive layer 837 comprises aluminum and has a coefficient of thermal expansion of about 24 ppm/C.

The thicknesses of the reflective layer 833, membrane layer 835, and conductive layer 837 can vary. The thickness of the reflective layer 833 can range from about 10 nm to about 110 nm. The thickness of the membrane layer 835 can range from about 50 nm to about 1050 nm. The thickness of the conductive layer 837 can range from about 10 nm to about 110 nm. The movable element 804b as a whole can be characterized by an effective coefficient of thermal expansion characteristic. As used herein “effective coefficient of thermal expansion” means the three-dimensional response to temperature change for a given object formed of two or more different materials. In general, the effective coefficient of thermal expansion (a_{effective}) for a layered object can be computed using the coefficient of thermal expansion (α) of each layer, the thickness (t) of each layer, and the Young's modulus value (E) of each layer. As shown below in Equation 1, the effective coefficient of thermal expansion for a layered object including three layers can be adjusted by the selection of material for each layer (e.g., by varying E and/or α) and/or by the selection of the thickness for each layer (e.g., by varying t). Accordingly, the effective coefficient of thermal expansion of the movable element 804b can be adjusted by selecting the thicknesses of certain layers and by selecting the materials for each layer.

$${α}_{effective} = \frac{{E}_{1} {t}_{1} {α}_{1} + {E}_{2} {t}_{2} {α}_{2} + {E}_{3} {t}_{3} {α}_{3}}{{E}_{1} {t}_{1} + {E}_{2} {t}_{2} + {E}_{3} {t}_{3}} \qquad [ Equation 1 ]$$

In some embodiments, the membrane layer 835 will comprise a material having a substantially lower coefficient of thermal expansion than the reflective layer 833 and/or conductive layer 837. In some embodiments, the effective coefficient of thermal expansion of the movable element 804b can be decreased by increasing the ratio of the membrane layer 833 thickness to the combined thickness of the reflective layer 833 and conductive layer 837. Similarly, the effective coefficient of thermal expansion of the movable element 804b can be increased by decreasing the thickness of the membrane layer 833 and increasing the thicknesses of the reflective layer 833 and conductive layer 837. In some embodiments, the effective coefficient of thermal expansion of the movable element 804b can be adjusted to substantially match the coefficient of thermal expansion of another component of a display device. For example, the effective coefficient of thermal expansion of the movable element 804b can be adjusted to substantially match the coefficient of thermal expansion of a substrate layer, for example, substrate 20 illustrated in FIG. 1

In embodiments of interferometric displays where each pixel comprises more than one sub-pixel, each movable element can have an effective coefficient of thermal expansion. The effective coefficient of thermal expansion of a movable layer can affect the overall temperature sensitivity of a sub-pixel. In general, a movable layer with an effective coefficient of thermal expansion that is substantially the same as the coefficient of thermal expansion of the substrate layer is not as sensitive to temperature as a movable layer with an effective coefficient of thermal expansion that is not substantially the same as the coefficient of thermal expansion of the substrate. For example, a sub-pixel including a movable layer with an effective coefficient of thermal expansion of 4 ppm/° C. and a substrate with a coefficient of thermal expansion of 3.7 ppm/° C. is less sensitive than a sub-pixel including a movable layer with an effective coefficient of thermal expansion of 3 ppm/° C. and a substrate with a coefficient of thermal expansion of 3.7 ppm/° C. Reducing temperature sensitivity can improve the overall performance of an interferometric display and simplify driver chip design.

In some embodiments, increasing the thickness of the membrane layer in order to adjust the effective coefficient of thermal expansion of the movable element can increase the overall stiffness of the movable element. Increasing the overall stiffness of the movable element can require a greater actuation voltage to move the movable element. In some embodiments, a movable element can be configured such that the overall stiffness of the movable element remains the same while the effective coefficient of thermal expansion of the movable element substantially matches the coefficient of thermal expansion of the substrate. The stiffness of a movable element (e.g., of a certain thickness) can be changed by forming one or more apertures (or “holes,” also sometimes referred to herein as “voids”) in the movable element as discussed in more detail below. In certain embodiments, a thinner portion of the movable element may be formed, instead of an aperture, which decreases the stiffness of the movable layer.

In some embodiments, a reflective display, for example, an interferometric display, can comprise one or more pixels that each comprise a plurality of sub-pixels. Each sub-pixel can comprise an independently movable and/or independently actuatable optical modulator. By such a configuration, a single pixel can be configured to reflect multiple colors, depending on the particular configuration of the individual sub-pixels and the selection of sub-pixels that are actuated. For example, in one embodiment, an interferometric display can be configured with pixels that are each divided into nine sub-pixels, with three sub-pixels in a column configured to reflect blue light, three sub-pixels in an adjacent column configured to reflect green light, and three sub-pixels in the next column configured to reflect red light in their unactuated (relaxed) states. In such a configuration, the modulators in the columns of a given pixel can have differently sized optical resonant cavities defined between the movable elements and absorber layers. In such an example, individually actuating different combinations of sub-pixels causes the pixel to reflect different colors.

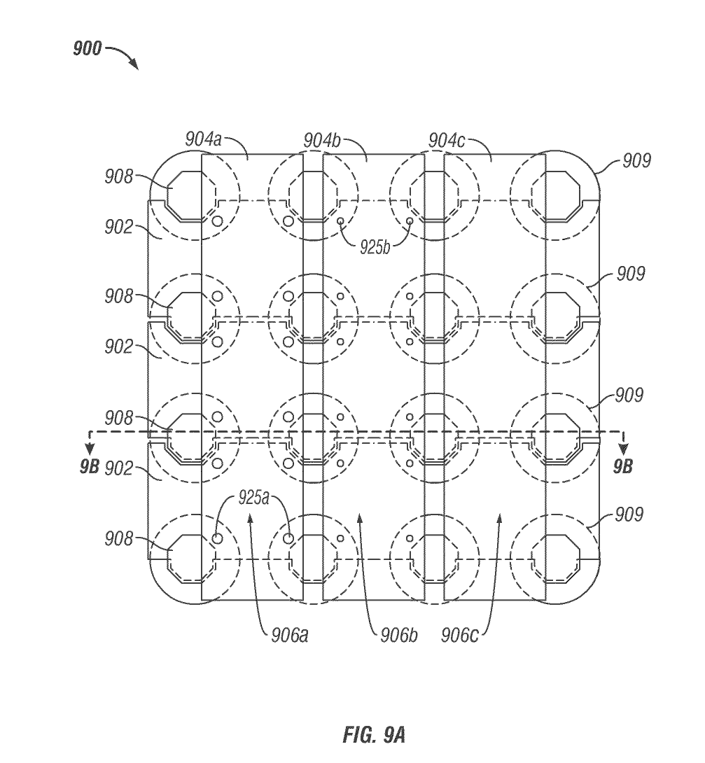

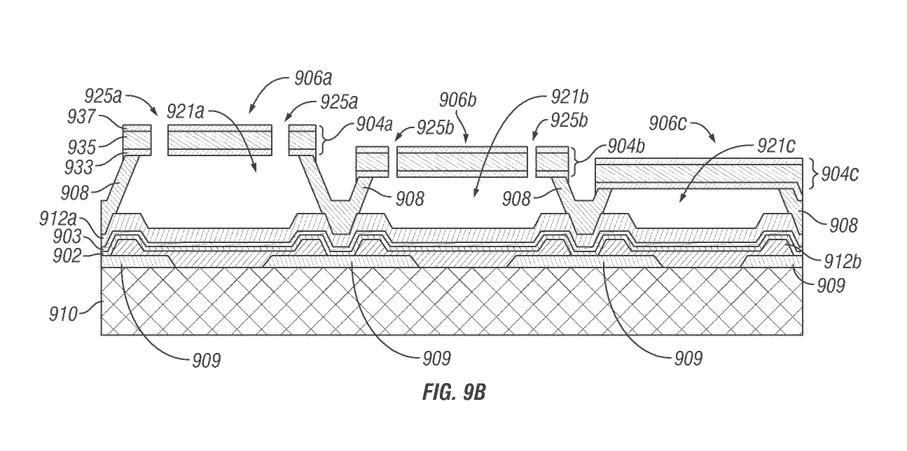

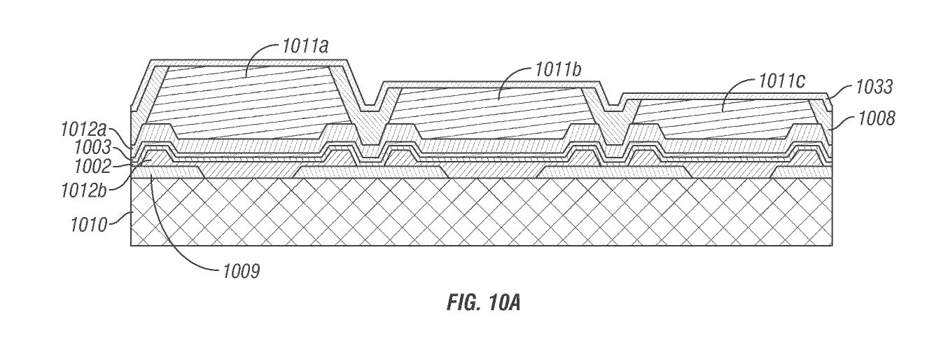

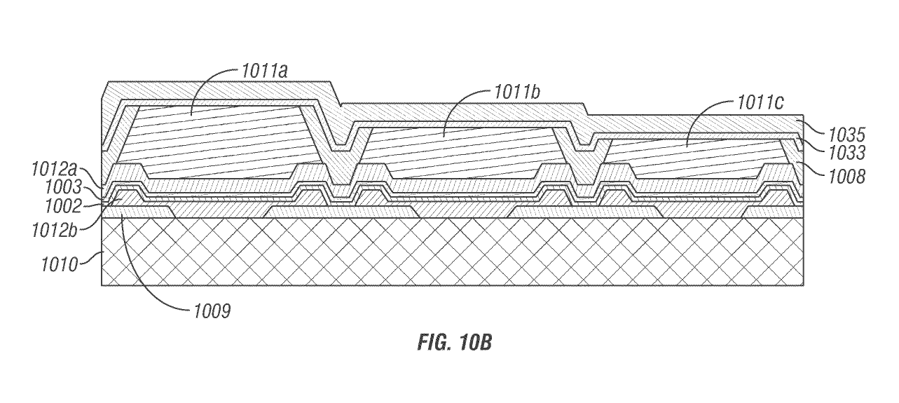

FIG. 9A is a top plan view depicting a portion of one embodiment of an interferometric display 900 that includes three parallel row electrodes 902 and three strips 904a, 904b, 904c of movable elements, arranged in columns extending perpendicular to the row electrodes 902. In the illustrated embodiment, the overlapping portions of the row electrodes 902 and the columns of movable elements 904 define nine sub-pixels 906 (comprising three each of sub pixels 906a, 906b, and 906c). Supports 908 are disposed at corner regions of each sub-pixel 906 and are configured to support edge portions of the movable elements 904. Those skilled in the art will understand that row electrodes can be electrically conductive portions of the optical stack. For example, in some embodiments, reference to row electrodes in this and the following discussion will be understood as a reference to the electrically conductive metal layer(s) (e.g., ITO) of an optical stack, for example, the optical stack 16 illustrated in FIGS. 7A-7E. Although FIG. 9A omits other layers of the optical stack (for example, a partially reflective layer or absorber, and/or one or more transparent dielectric layers) for clarity, those skilled in the art will understand that other layers can be present as desired for particular applications.

Still referring to FIG. 9A, optical mask structures 909 are disposed under the row electrodes 902 and movable elements 904. The optical mask structures 909 can be configured to absorb ambient or stray light and to improve the optical response of a display device by increasing the contrast ratio. In some applications, the optical mask 909 can also be conductive, and thus can be configured to function as an electrical buss. Such conductive bus structures can be configured to have a lower electrical resistance than the row electrodes 902 and/or the movable elements 904 to improve the response time of the sub-pixels in an array. For example, the conductive bus structures can comprise materials having low electrical resistance, and/or can be configured with a cross-sectional area larger than the cross-sectional area of the row electrodes 902 and/or the movable elements 904. A conductive bus structure can also be provided separately from the optical mask structure 909. An optical mask 909 or other conductive bus structure can be electrically coupled to one or more of the elements on the display to provide one or more electrical paths for voltages applied to one or more of the display elements, for example, the movable elements 904. In some embodiments, the conductive bus structures can be connected to the row electrodes 902 through one or more vias which can be disposed underneath the supports 908 or in another suitable location.

In the illustrated embodiment, two of the movable elements 904a, 904b include a plurality of voids 925 located near the corners of each sub-pixel 906. The voids 925 are disposed such that they are over the optical masks 909. The voids 925 may be configured to decrease the stiffness of a movable element 904 a selectable amount. As shown, the size of the voids 925 can vary from movable element 904 to movable element such that the stiffness of each movable element may also vary, based on the particular configuration of the one or more voids in the movable element. For example, voids 925a disposed in movable element 904a may be larger than voids 925b in movable element 904b. Additionally, the size of voids 925 on a given movable element 904 can vary in size and/or shape from one another. For example, a movable element can include a first void having a first size and a second void having a second size, wherein the first size and second sizes are different. In general, larger voids 925 will decrease the stiffness of a movable element 904 more than smaller voids 925.

The voids 925 can be configured to have different shapes. For example, voids 925 can be generally round, generally circular, generally curvilinear, generally polygonal, and/or irregularly shaped. The voids on a given display can all be similarly shaped or differently shaped. The voids 925 can be located anywhere on the movable elements 904. However, voids 925 disposed underneath an optical mask 909 such that the voids are outside of the active area of the display may not result in a diminished contrast ratio whereas voids placed in other locations can decrease the contrast of the display device.

In the illustrated embodiment, the voids 925a in sub-pixel 906a are larger than the voids 925b in sub-pixel 906b, and sub-pixel 906c does not include any voids. Accordingly, the stiffness of each the movable elements 904 in each sub-pixel 906a, 906b, and 906c are different. In other words, the stiffness of a movable element 904 having one or more voids 925 will be less than a movable element without a void 925. The stiffness of each movable element 904 can be selected such that the same actuation voltage is required to actuate each sub-pixel even though the thicknesses of the optical resonant cavities can vary from sub-pixel to sub-pixel as illustrated in FIG. 9B and discussed in more detail below.

FIG. 9B shows a cross-section of a portion of the display 900 illustrated in FIG. 9A taken along the line 9B-9B, and also shows a substrate 910 underlying the optical stack, which includes row electrodes 902, a partially reflective and partially transmissive layer (e.g., an absorber) 903, and dielectric layers 912a, 912b. The substrate 910 can comprise any suitable substrate, for example, glass. The substrate 910 can be characterized by a coefficient of thermal expansion which results from the material composition of the substrate.

In some embodiments, the movable elements 904 can comprise multiple layers. For example, the movable elements 904 illustrated in FIG. 9B comprise a reflective layer 933, a membrane layer 935, and a conductive layer 937. The movable elements 904 can be adjusted to have a certain effective coefficient of thermal expansion depending on the coefficient of thermal expansion of each layer and on the relative thickness of each layer. In one embodiment, the movable elements 904 can be selected to have an effective coefficient of thermal expansion that is substantially the same as the coefficient of thermal expansion of the substrate 910. In some embodiments, the movable elements 904 can be selected to have an effective coefficient of thermal expansion that is substantially less than the coefficient of thermal expansion of the reflective layer 933 and/or of the conductive layer 937.

As shown in FIG. 9B, optical masks 909 are disposed such that they are between the substrate 910 and the voids 925a, 925b. Thus, the voids 925 can be hidden from a viewer viewing the display 900 from the substrate 910 side of the display. Also shown in FIG. 9B are gaps 921. The gaps 921 are defined between the movable elements 904 and the dielectric layer 912a. The gaps 921 may vary between movable elements 921. For example, each movable element may have a differently sized gap. In the illustrated embodiment, gap 921a is thicker than gap 921b which is thicker than gap 921c.

The movable elements 904 are configured to move relative to the absorber layer 903 through the gaps 921 when they are actuated by an actuation voltage. In some embodiments, the movable elements 904 can be configured to move through the gaps 921 such that they contact the dielectric layer 912a when actuated. In embodiments where the gaps 921 have different thicknesses, the movable elements 904 may be configured to move different distances when actuated. In such embodiments, it can be preferable to apply the same actuation voltage to each movable element 904 although the movable elements are configured to move different distances through the gaps 921. Accordingly, in some embodiments, the movable elements 904 can be configured to have a different stiffness.

In the embodiment illustrated in FIG. 9B, each movable element 904 has substantially the same thickness. Furthermore, each reflective layer 933, membrane layer 935, and conductive layer 937 has substantially the same thickness resulting in three different movable elements 904 that each have an effective coefficient of thermal expansion that is substantially the same as the other two movable elements. Although the movable elements can be configured to have substantially the same overall thickness and effective coefficient of thermal expansion, the movable elements can be configured to have a different stiffness by incorporating one or more voids 925. For example, movable element 904a can be configured to move a greater distance than movable element 904b when the same actuation voltage is applied to each movable element by configuring movable element 904b to have a greater overall stiffness than movable element 904a.

In some embodiments, one or more movable elements 904 can comprise multiple membrane layers disposed between the reflective layer and the conductive layer. For example, one movable element can comprise two membrane layers and have a greater overall thickness than other movable elements that comprise a single membrane layer. Thus, the overall thicknesses of each movable element do not need to be identical and the effective coefficients of thermal expansion do not need to be identical.

As mentioned above, the effect voids have on the overall stiffness of a movable element depends in part on the size, shape, distribution, and location of the void(s). In some embodiments, each movable element 904 can include one or more voids to adjust the stiffness of the movable element. In other embodiments, one or more movable elements are configured without any voids while other movable elements include voids to adjust the stiffness of those movable elements.

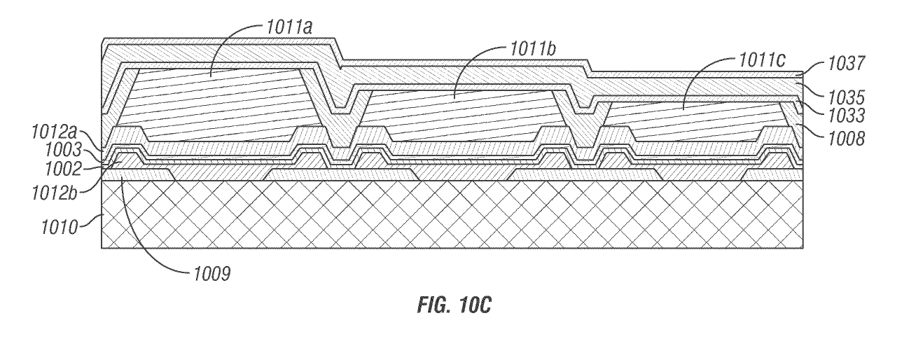

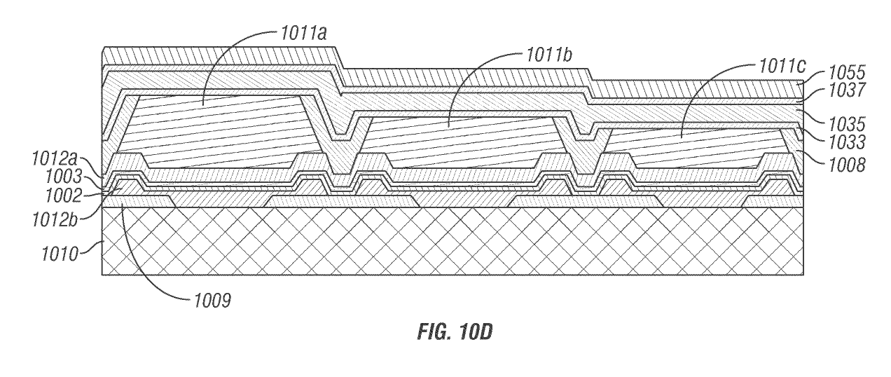

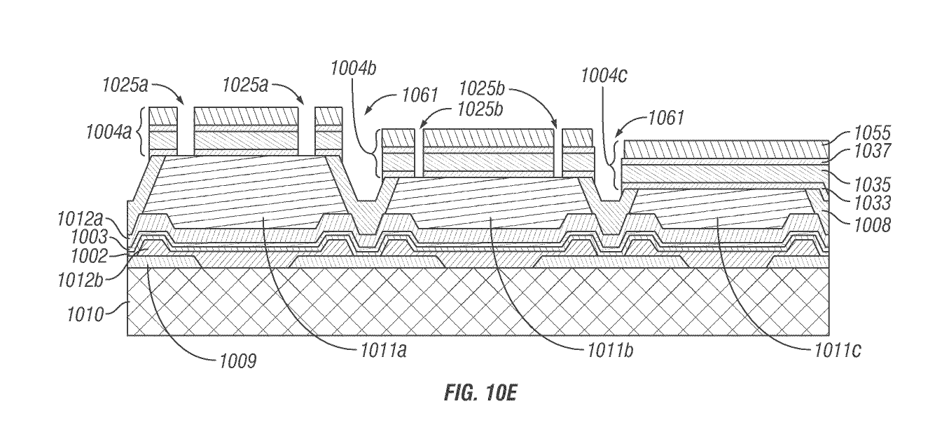

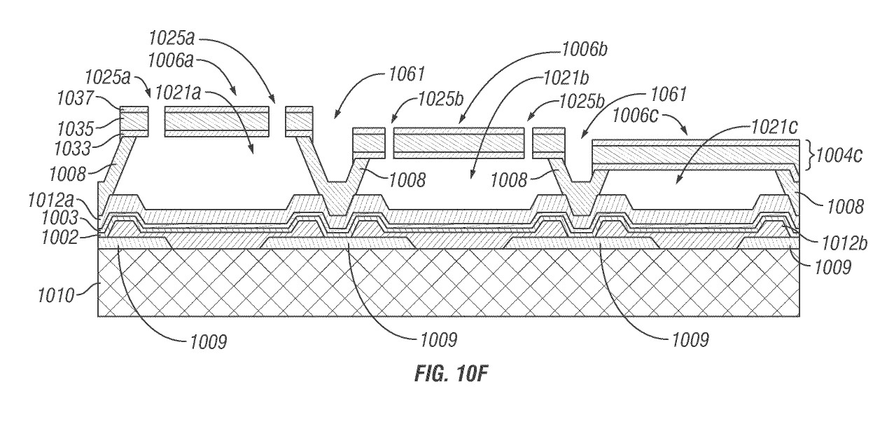

In addition to reducing the temperature sensitivity of a display, manufacturing a display wherein each movable element has substantially the same thickness and the same number of layers can reduce the number of masks required in manufacturing. FIGS. 10A-10F are schematic cross-sectional views illustrating steps in an embodiment of a method for manufacturing an interferometric display wherein each movable element has substantially the same effective coefficient of thermal expansion and each movable element has a different overall stiffness.

FIG. 10A shows an embodiment of a light guide including a substrate 1010, optical masks 1009 formed on the substrate, a dielectric layer 1012b disposed on the substrate 1010, a row electrode 1002 formed on the dielectric layer 1012b, an absorber 1003 disposed on the dielectric layer 1012b, and another dielectric layer 1012a disposed on the absorber 1003. A reflective layer 1033 is formed on supports 1008 that support the reflective layer 1033 over the dielectric layer 1012a. The reflective layer 1033 can comprise any reflective material, for example, aluminum. Sacrificial layers 1011 are disposed in the spaces between the reflective layer 1033, supports 1008, and dielectric layer 1012a. In some embodiments, the sacrificial layers 1011 comprise a photoresist material or other dissolvable material, for example, an XeF₂-etchable such as molybdenum or amorphous silicon. Deposition of the sacrificial material can be carried out using deposition techniques such as physical vapor deposition (PVD, e.g., sputtering), plasma-enhanced chemical vapor deposition (PECVD), thermal chemical vapor deposition (thermal CVD), or spin-coating. The reflective layer 1033 can be formed using one or more deposition steps along with one or more patterning, masking, and/or etching steps.

FIG. 10B shows a membrane layer 1035 deposited over the reflective layer 1033 depicted in FIG. 10A. The membrane layer 1035 can comprise any dielectric or insulating material, for example, silicon oxy-nitride. FIG. 10C shows a conductive layer 1037 deposited over the membrane layer 1035. The conductive layer 1037 can comprise any conductive material, for example aluminum. The reflective layer 1033, membrane layer 1035, and conductive layer 1037 can be configured such that the effective coefficient of thermal expansion of all three layers is substantially similar to the coefficient of thermal expansion of the substrate 1010.

FIG. 10D shows a hard-mask layer 1055 deposited over the conductive layer 1037. The hard-mask layer 1055 can comprise any suitable hard-mask material, for example, molybdenum. Once the hard-mask layer 1055 has been deposited, the reflective layer 1033, membrane layer 1035, and conductive layer 1037 can be processed with lithography and etch steps. In this step, the reflective layer 1033, membrane layer 1035, and conductive layer 1037 can be separated between supports 1008 to form separate movable elements 1004 as shown in FIG. 10E. The movable elements can be separated by spaces 1061. Furthermore, voids 1025 may be etched into one or more movable elements 1004 to adjust the stiffness of these movable elements. The voids 1025 may be similarly sized and shaped or they may be differently sized as shown. In one embodiment, the size and/or shape of voids 1025 can be chosen based on the desired stiffness of the movable element. FIG. 10F illustrates a last step in an embodiment of a method for manufacturing an interferometric display wherein the sacrificial layers 1011 are removed. The sacrificial layers 1011 can be removed by dry chemical etching, for example, by exposing the sacrificial layer to a gaseous or vaporous etchant, including vapors derived from solid xenon difluoride (XeF₂) for a period of time that is effective to remove the desired amount of material, typically selectively relative to the structures surrounding the layers 1011. Other etching methods, for example, wet etching and/or plasma etching, may also be used. Removing the sacrificial layers 1011 results in gaps 1021 defined between the movable elements 1004 and the dielectric layer 1012a and allows the movable elements 1004 to move relative to the substrate 1010.

In the method depicted in FIGS. 10A-10F, the membrane layers 1004a, 1004b, and 1004c are formed from a single membrane layer deposition process. However, in other embodiments, membrane layers in movable elements can comprise more than one layer. Furthermore, in some embodiments, one movable element can comprise more membrane layers than another movable element. For example, membrane layers can be formed in a two mask process or a three mask process resulting in membrane layers having different thicknesses.

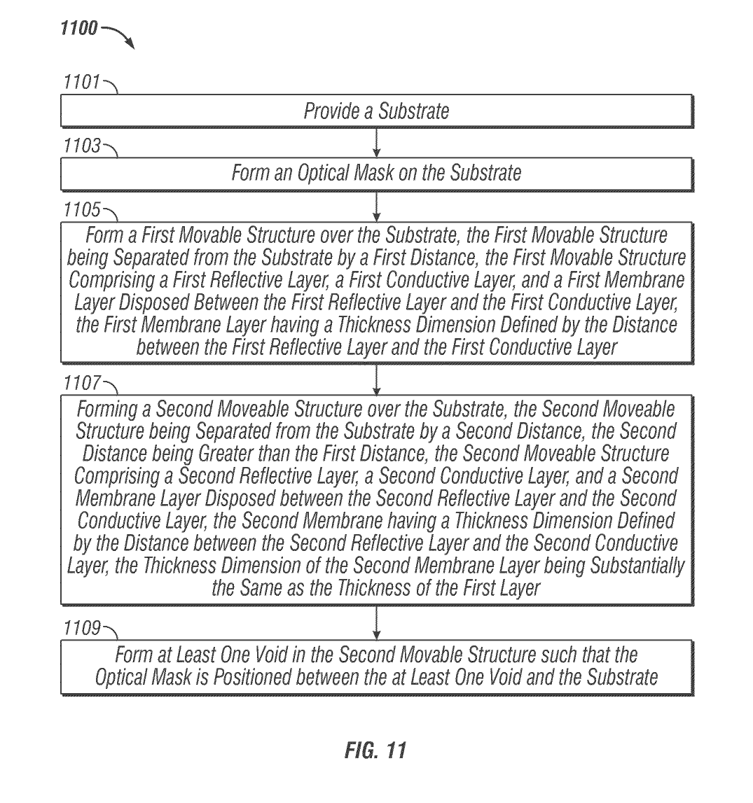

FIG. 11 is a block diagram depicting a method 1100 of manufacturing an interferometric pixel, according to one embodiment. Method 1100 includes the steps of providing a substrate as illustrated in block 1101, forming an optical mask on the substrate as illustrated in block 1103, forming a first movable structure over the substrate, the first movable structure being separated from the substrate by a first distance, the first movable structure comprising a first reflective layer, a first conductive layer, and a first membrane layer disposed between the first reflective layer and the first conductive layer, the first membrane layer having a thickness dimension defined by the distance between the first reflective layer and the first conductive layer as illustrated in block 1105, forming a second movable structure over the substrate, the second movable structure being separated from the substrate by a second distance, the second distance being greater than the first distance, the second movable structure comprising a second reflective layer, a second conductive layer, and a second membrane layer disposed between the second reflective layer and the second conductive layer, the second membrane having a thickness dimension defined by the distance between the second reflective layer and the second conductive layer, the thickness dimension of the second membrane layer being substantially the same as the thickness of the first membrane layer as illustrated in block 1107, and forming at least one void in the second movable structure such that optical mask is positioned between the at least one void and the substrate as illustrated in block 1109.

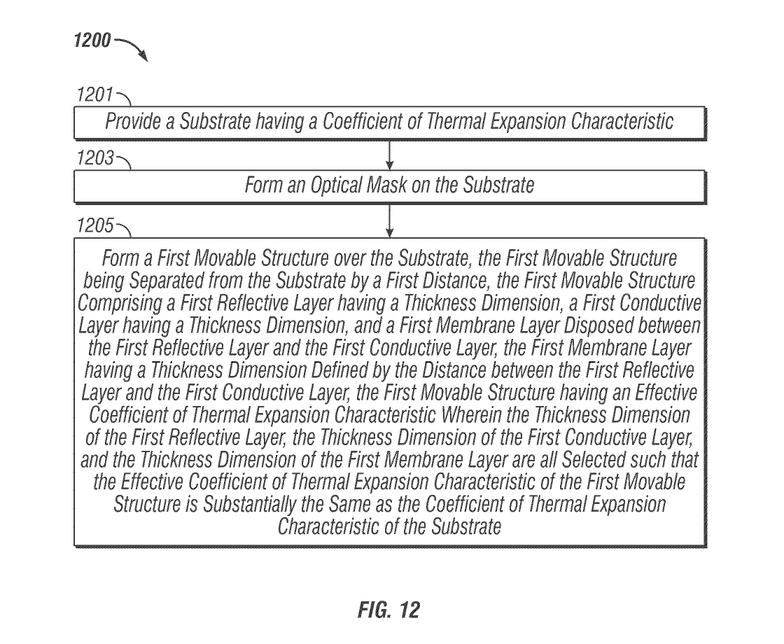

FIG. 12 is a block diagram depicting a method 1200 of manufacturing an interferometric pixel, according to one embodiment. Method 1200 includes the steps of providing a substrate having a coefficient of thermal expansion characteristic as illustrated in block 1201, forming an optical mask on the substrate as illustrated in block 1203, and forming a first movable structure over the substrate, the first movable structure being separated from the substrate by a first distance, the first movable structure comprising a first reflective layer having a thickness dimension, a first conductive layer having a thickness dimension, and a first membrane layer disposed between the first reflective layer and the first conductive layer, the first membrane layer having a thickness dimension defined by the distance between the first reflective layer and the first conductive layer, the first movable structure having an effective coefficient of thermal expansion characteristic, wherein the thickness dimension of the first reflective layer, the thickness dimension of the first conductive layer, and the thickness dimension of the first membrane layer are all selected such that the effective coefficient of thermal expansion characteristic of the first movable structure is substantially the same as the coefficient of thermal expansion characteristic of the substrate as illustrated in block 1205.

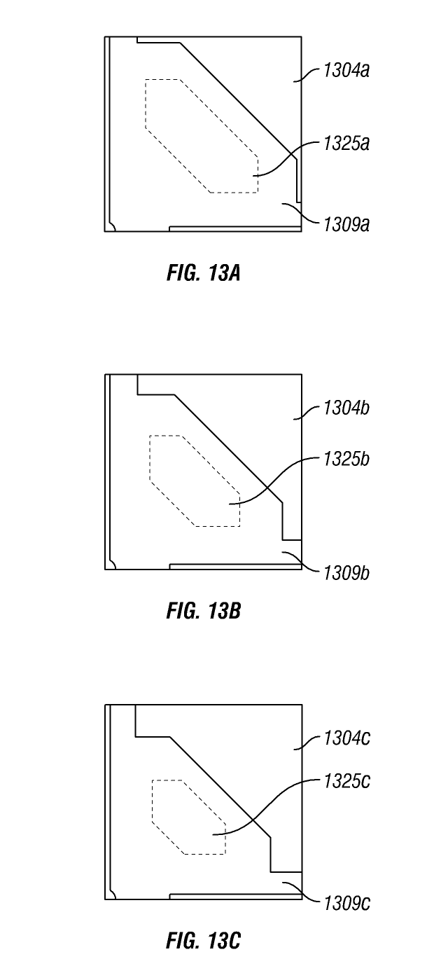

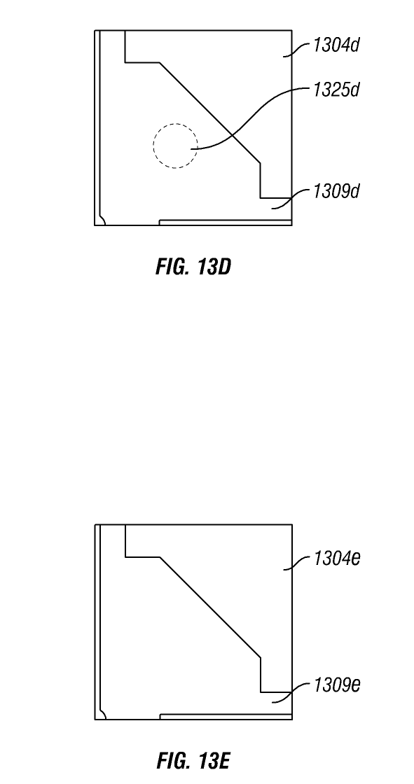

FIG. 13A shows a top view of an embodiment of a movable element 1304a that includes a void 1325a disposed in a corner of the movable element under an optical mask 1309a. The void 1325a can be polygonal and have an area of about 27 square μm. The movable element 1304a can include a reflective layer, a membrane layer, and a conductive layer. The reflective layer and conductive layer can each be about 30 nm thick and comprise an aluminum copper alloy having a Young's modulus of about 70 GPa and a coefficient of thermal expansion of about 24 ppm/° C. In some embodiments, the membrane layer can comprise silicon oxy-nitride having a Young's modulus of 160 GPa, a coefficient of thermal expansion of about 2.6 ppm/° C., and a thickness between about 75 nm and about 160 nm.

Still referring to FIG. 13A, in one embodiment, the membrane layer comprises a 75 nm thick layer of silicon oxy-nitride having a Young's modulus of about 160 GPa and a coefficient of thermal expansion of about 2.6 ppm/° C. In this embodiment, the overall stiffness of the movable layer 1304a is about 18 Pa/nm and the effective coefficient of thermal expansion of the movable layer is about 8.1 ppm/° C. In another embodiment, the membrane layer comprises a 115 nm thick layer of silicon oxy-nitride having a Young's modulus of about 160 GPa and a coefficient of thermal expansion of about 2.6 ppm/° C. In this embodiment, the overall stiffness of the movable layer 1304a is about 28 Pa/nm and the effective coefficient of thermal expansion of the movable layer is about 6.6 ppm/° C. In another embodiment, the membrane layer comprises a 160 nm thick layer of silicon oxy-nitride having a Young's modulus of about 160 GPa and a coefficient of thermal expansion of about 2.6 ppm/° C. In this embodiment, the overall stiffness of the movable layer 1304a is about 42 Pa/nm and the effective coefficient of thermal expansion of the movable layer is about 5.6 ppm/° C.

FIG. 13B shows a top view of an embodiment of a movable element 1304b that includes a void 1325b disposed in a corner of the movable element under an optical mask 1309b. The void 1325b can be generally polygonal and have an area of about 22 square μm. The movable element 1304b can include a reflective layer, a membrane layer, and a conductive layer. The reflective layer and conductive layer can each be about 30 nm thick and comprise an aluminum copper alloy having a Young's modulus of about 70 GPa and a coefficient of thermal expansion of about 24 ppm/° C. In some embodiments, the membrane layer can comprise silicon oxy-nitride having a Young's modulus of about 160 GPa, a coefficient of thermal expansion of about 2.6 ppm/° C., and a thickness between about 75 nm and about 160 nm.

Still referring to FIG. 13B, in one embodiment, the membrane layer comprises a 75 nm thick layer of silicon oxy-nitride having a Young's modulus of about 160 GPa and a coefficient of thermal expansion of about 2.6 ppm/° C. In this embodiment, the overall stiffness of the movable layer 1304b is about 27 Pa/nm and the effective coefficient of thermal expansion of the movable layer is about 8.1 ppm/° C. In another embodiment, the membrane layer comprises a 115 nm thick layer of silicon oxy-nitride having a Young's modulus of about 160 GPa and a coefficient of thermal expansion of about 2.6 ppm/° C. In this embodiment, the overall stiffness of the movable layer 1304b is about 38 Pa/nm and the effective coefficient of thermal expansion of the movable layer is about 6.6 ppm/° C. In another embodiment, the membrane layer comprises a 160 nm thick layer of silicon oxy-nitride having a Young's modulus of about 160 GPa and a coefficient of thermal expansion of about 2.6 ppm/° C. In this embodiment, the overall stiffness of the movable layer 1304a is about 55 Pa/nm and the effective coefficient of thermal expansion of the movable layer is about 5.6 ppm/° C.

FIG. 13C shows a top view of an embodiment of a movable element 1304c that includes a void 1325c disposed in a corner of the movable element under an optical mask 1309c. The void 1325c can be generally polygonal and have an area of about 17 square μm. The movable element 1304c can include a reflective layer, a membrane layer, and a conductive layer. The reflective layer and conductive layer can each be about 30 nm thick and comprise an aluminum copper alloy having a Young's modulus of 70 GPa and a coefficient of thermal expansion of about 24 ppm/° C. In some embodiments, the membrane layer can comprise silicon oxy-nitride having a Young's modulus of 160 GPa, a coefficient of thermal expansion of about 2.6 ppm/° C., and a thickness between about 75 nm and about 160 nm.

Still referring to FIG. 13C, in one embodiment, the membrane layer comprises a 75 nm thick layer of silicon oxy-nitride having a Young's modulus of about 160 GPa and a coefficient of thermal expansion of about 2.6 ppm/° C. In this embodiment, the overall stiffness of the movable layer 1304c is about 41 Pa/nm and the effective coefficient of thermal expansion of the movable layer is about 8.1 ppm/° C. In another embodiment, the membrane layer comprises a 115 nm thick layer of silicon oxy-nitride having a Young's modulus of about 160 GPa and a coefficient of thermal expansion of about 2.6 ppm/° C. In this embodiment, the overall stiffness of the movable layer 1304c is about 53 Pa/nm and the effective coefficient of thermal expansion of the movable layer is about 6.6 ppm/° C. In another embodiment, the membrane layer comprises a 160 nm thick layer of silicon oxy-nitride having a Young's modulus of about 160 GPa and a coefficient of thermal expansion of about 2.6 ppm/° C. In this embodiment, the overall stiffness of the movable layer 1304c is about 80 Pa/nm and the effective coefficient of thermal expansion of the movable layer is about 5.6 ppm/° C.

FIG. 13D shows a top view of an embodiment of a movable element 1304d that includes a void 1325d disposed in a corner of the movable element under an optical mask 1309d. The void 1325d can be generally curvilinear and have an area of about 9 square μm. The movable element 1304d can include a reflective layer, a membrane layer, and a conductive layer. The reflective layer and conductive layer can each be about 30 nm thick and comprise an aluminum copper alloy having a Young's modulus of about 70 GPa and a coefficient of thermal expansion of about 24 ppm/° C. In some embodiments, the membrane layer can comprise silicon oxy-nitride having a Young's modulus of about 160 GPa, a coefficient of thermal expansion of about 2.6 ppm/° C., and a thickness between about 75 nm and about 160 nm.

Still referring to FIG. 13D, in one embodiment, the membrane layer comprises a 75 nm thick layer of silicon oxy-nitride having a Young's modulus of about 160 GPa and a coefficient of thermal expansion of about 2.6 ppm/° C. In this embodiment, the overall stiffness of the movable layer 1304d is about 62 Pa/nm and the effective coefficient of thermal expansion of the movable layer is about 8.1 ppm/° C. In another embodiment, the membrane layer comprises a 115 nm thick layer of silicon oxy-nitride having a Young's modulus of about 160 GPa and a coefficient of thermal expansion of about 2.6 ppm/° C. In this embodiment, the overall stiffness of the movable layer 1304c is about 86 Pa/nm and the effective coefficient of thermal expansion of the movable layer is about 6.6 ppm/° C. In another embodiment, the membrane layer comprises a 160 nm thick layer of silicon oxy-nitride having a Young's modulus of about 160 GPa and a coefficient of thermal expansion of about 2.6 ppm/° C. In this embodiment, the overall stiffness of the movable layer 1304c is about 95 Pa/nm and the effective coefficient of thermal expansion of the movable layer is about 5.6 ppm/° C.

FIG. 13E shows a top view of an embodiment of a movable element 1304e that does not include a void. The movable element 1304e can include a reflective layer, a membrane layer, and a conductive layer. The reflective layer and conductive layer can each be about 30 nm thick and comprise an aluminum copper alloy having a Young's modulus of about 70 GPa and a coefficient of thermal expansion of about 24 ppm/° C. In some embodiments, the membrane layer can comprise silicon oxy-nitride having a Young's modulus of about 160 GPa, a coefficient of thermal expansion of about 2.6 ppm/° C., and a thickness between about 75 nm and about 160 nm.

Still referring to FIG. 13E, in one embodiment, the membrane layer comprises a 75 nm thick layer of silicon oxy-nitride having a Young's modulus of about 160 GPa and a coefficient of thermal expansion of about 2.6 ppm/° C. In this embodiment, the overall stiffness of the movable layer 1304e is about 75 Pa/nm and the effective coefficient of thermal expansion of the movable layer is about 8.1 ppm/° C. In another embodiment, the membrane layer comprises a 115 nm thick layer of silicon oxy-nitride having a Young's modulus of about 160 GPa and a coefficient of thermal expansion of about 2.6 ppm/° C. In this embodiment, the overall stiffness of the movable layer 1304e is about 101 Pa/nm and the effective coefficient of thermal expansion of the movable layer is about 6.6 ppm/° C. In another embodiment, the membrane layer comprises a 160 nm thick layer of silicon oxy-nitride having a Young's modulus of about 160 GPa and a coefficient of thermal expansion of about 2.6 ppm/° C. In this embodiment, the overall stiffness of the movable layer 1304e is about 108 Pa/nm and the effective coefficient of thermal expansion of the movable layer is about 5.6 ppm/° C.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. An interferometric display comprising:
a substrate having a coefficient of thermal expansion characteristic;
an optical mask disposed on the substrate;
an absorber disposed on the substrate;
a first sub-pixel comprising
a first movable reflector configured to move in a direction substantially perpendicular to the substrate between an unactuated position and an actuated position when a voltage is applied to the first movable reflector, the first movable reflector having an effective coefficient of thermal expansion characteristic that is substantially the same as the coefficient of thermal expansion characteristic of the substrate, the first movable reflector comprising
a first reflective layer,
a first conductive layer, and
a first membrane layer disposed at least partially between the first reflective layer and the first conductive layer,
a first electrode configured to apply a voltage to the first movable reflector, and
a first cavity defined by a surface of the first movable reflector and a surface of the absorber; and
a second sub-pixel comprising
a second movable reflector configured to move in a direction substantially perpendicular to the substrate between an unactuated position and an actuated position when a voltage is applied to the second movable reflector, the second movable reflector having an effective coefficient of thermal expansion characteristic that is substantially the same as the coefficient of thermal expansion characteristic of the substrate, the second movable reflector comprising
a second reflective layer,
a second conductive layer, and
a second membrane layer disposed at least partially between the second reflective layer and the second conductive layer, the second membrane layer comprising at least one void, wherein the void is configured to increase the flexibility of the second membrane layer, wherein at least a portion of the optical mask is disposed between the at least one void and the substrate,
a second electrode configured to apply a voltage to the second movable reflector, and
a second cavity defined by a surface of the second movable reflector and a surface of the absorber.

2. The interferometric display of claim 1, wherein at least one edge of the second membrane layer surrounding the at least one void is at least partially curvilinear.

3. The interferometric display of claim 2, wherein a surface of the second membrane layer surrounding the void is columnar.

4. The interferometric display of claim 1, wherein at least a portion of the optical mask is disposed between the first membrane layer and the substrate.

5. The interferometric display of claim 4, wherein the first movable reflector and second movable reflector are disposed adjacent to one another.

6. The interferometric display of claim 1, wherein the coefficient of thermal expansion characteristic of the substrate is about 3.7 ppm/° C.

7. The interferometric display of claim 1, wherein the second reflective layer comprises at least one void, wherein the at least a portion of the optical mask is disposed between the at least one void and the substrate.

8. The interferometric display of claim 7, wherein the at least one void in the second reflective layer is generally aligned with the at least one void in the second membrane layer.

9. The interferometric display of claim 8, wherein the second conductive layer comprises at least one void, wherein the void is generally aligned with the at least one void in the second reflective layer.

10. A pixel comprising:
a substrate layer having a coefficient of thermal expansion characteristic;
an absorber disposed on the substrate;
a first sub-pixel comprising
a first movable reflector configured to move in a direction substantially perpendicular to the absorber between an unactuated position and an actuated position when a voltage is applied to the first movable reflector, the first movable reflector having an effective coefficient of thermal expansion characteristic that is substantially the same as the coefficient of thermal expansion characteristic of the substrate, the first movable reflector comprising
a first reflective layer,
a first conductive layer, and
a first membrane layer disposed at least partially between the first reflective layer and the first conductive layer, the first membrane layer having a thickness dimension defined by the distance between the first reflective layer and the first conductive layer,
a first electrode configured to apply a voltage to the first movable reflector to move the first movable reflector from the unactuated position to the actuated position, and
a first cavity defined by a surface of the first movable reflector and a surface of the absorber, the first cavity having a height dimension defined by the distance between the first movable reflector and the absorber when the first movable reflector is in the unactuated position; and
a second sub-pixel comprising
a second movable reflector configured to move in a direction substantially perpendicular to the substrate between an unactuated position and an actuated position when a voltage is applied to the second movable reflector, the second movable reflector having an effective coefficient of thermal expansion characteristic that is substantially the same as the coefficient of thermal expansion characteristic of the substrate, the second movable reflector comprising
a second reflective layer,
a second conductive layer, and
a second membrane layer disposed at least partially between the second reflective layer and the second conductive layer, the second membrane layer having a thickness dimension defined by the distance between the second reflective layer and the second conductive layer, the thickness dimension of the second membrane layer being substantially the same as the thickness dimension of the first membrane layer, the second membrane layer comprising at least one void; wherein the void is configured to increase the flexibility of the second membrane layer such that the second movable reflector moves a greater distance than the first movable reflector when an equal voltage is applied to the first movable reflector and the second movable reflector,
a second electrode configured to apply a voltage to the second movable reflector, the voltage applied by the second electrode being substantially the same as the voltage applied by the first electrode, and
a second cavity defined by a surface of the second movable reflector and a surface of the absorber, the second cavity having a height dimension defined by the distance between the second movable reflector and the absorber when the second movable reflector is in the unactuated position, the height dimension of the second cavity being greater than the height dimension of the first cavity.

11. The pixel of claim 10, wherein the first cavity comprises an optically resonant material.

12. The pixel of claim 11, wherein the first cavity comprises air.

13. The pixel of claim 10, wherein the second cavity comprises an optically resonant material.

14. The pixel of claim 13, wherein the second cavity comprises air.

15. The pixel of claim 10, wherein the pixel is an interferometric pixel.

16. The pixel of claim 10, wherein the coefficient of thermal expansion characteristic of the substrate layer is about 3.7 ppm/° C.

17. The pixel of claim 10, wherein the first membrane layer comprises a dielectric material.

18. The pixel of claim 17, wherein the second membrane layer comprises a dielectric material.

19. The pixel of claim 10, wherein the first membrane layer comprises silicon oxy-nitride.

20. The pixel of claim 19, wherein the second membrane layer comprises silicon oxy-nitride.

21. The pixel of claim 10, wherein the first reflective layer comprises aluminum.

22. The pixel of claim 10, wherein the first conductive layer comprises aluminum.

23. The pixel of claim 10, wherein the second reflective layer comprises aluminum.

24. The pixel of claim 10, wherein the second conductive layer comprises aluminum.

25. The pixel of claim 10, wherein the thickness of the first membrane layer is about 1600 Å.

26. The pixel of claim 10, wherein the first membrane layer comprises a void, the void in the first membrane layer being smaller than the void in the second membrane layer.

27. The pixel of claim 10, further comprising an optical mask disposed between at least a portion of the second sub-pixel and the substrate.

28. The pixel of claim 27, wherein at least a portion of the optical mask is disposed between the at least one void and the substrate.

29. The pixel of claim 28, wherein the optical mask is disposed between at least a portion of the first sub-pixel and the substrate.

30. The pixel of claim 29, wherein the first sub-pixel is disposed adjacent to the second sub-pixel.

31. The pixel of claim 10, further comprising:
a display;
a processor that is configured to communicate with the display, the processor being configured to process image data; and
a memory device that is configured to communicate with the processor.

32. The pixel of claim 31, further comprising a driver circuit configured to send at least one signal to the display.

33. The pixel of claim 32, further comprising a controller configured to send at least a portion of the image data to the driver circuit.

34. The pixel of claim 31, further comprising an image source module configured to send the image data to the processor.

35. The pixel of claim 34, wherein the image source module comprises at least one of a receiver, transceiver, and transmitter.

36. The pixel of claim 31, further comprising an input device configured to receive input data and to communicate the input data to the processor.

37. A pixel for use in a reflective display, the pixel comprising:
a substrate layer having a coefficient of thermal expansion characteristic;
an absorber layer disposed on the substrate layer; and
a plurality of sub-pixels, each sub-pixel comprising a movable reflector configured to move relative to the absorber layer, each movable reflector comprising
a reflective layer having a first thickness,
a conductive layer having a second thickness, and
a membrane layer disposed at least partially between the reflective layer and the conductive layer, the membrane layer having a third thickness,
wherein each movable reflector is configured to move between an unactuated position and an actuated position when a voltage value is applied to the sub-pixel,
wherein the same voltage value is applied to each movable reflector independently,
wherein a first sub-pixel has a first membrane layer that is more flexible than a second membrane layer in a second sub-pixel such that the first membrane layer moves a greater distance than the second membrane layer when the voltage value is applied, and
wherein each moveable reflector has an effective coefficient of thermal expansion characteristic that is substantially the same as the coefficient of thermal expansion characteristic of the substrate layer.

38. The pixel of claim 37, wherein the third thickness is greater than the first and second thicknesses.

39. The pixel of claim 38, wherein the first and second thicknesses are substantially the same.

40. The pixel of claim 37, wherein at least one membrane layer comprises a void.

41. The pixel of claim 37, further comprising a plurality of electrodes each configured to apply the voltage value to a movable reflector.

42. An interferometric pixel comprising:
a substrate having a coefficient of thermal expansion characteristic;
an optical mask means disposed on the substrate;
an absorber means for absorbing certain wavelengths of electromagnetic radiation, the absorber means disposed on the substrate;
a first sub-pixel means comprising
a first movable reflector means configured to move in a direction substantially perpendicular to the substrate between an unactuated position and an actuated position when a voltage is applied to the first movable reflector means, the first movable reflector means having an effective coefficient of thermal expansion characteristic that is substantially the same as the coefficient of thermal expansion characteristic of the substrate, the first movable reflector means comprising
a first reflective means,
a first conductive means, and
a first membrane means disposed at least partially between the first reflective means and the first conductive means,
a first voltage applying means configured to apply a voltage value to the first movable reflector means, and
a first cavity defined by a surface of the first movable reflector means and a surface of the absorber means; and
a second sub-pixel means comprising
a second movable reflector means configured to move in a direction substantially perpendicular to the substrate between an unactuated position and an actuated position when a voltage is applied to the second movable reflector means, the second movable reflector means having an effective coefficient of thermal expansion characteristic that is substantially the same as the coefficient of thermal expansion coefficient of the substrate, the second movable reflector means comprising
a second reflective means,
a second conductive means, and
a second membrane means disposed at least partially between the second reflective means and the second conductive means, the second membrane means comprising at least one void, wherein the void is configured to increase the flexibility of the second membrane means, wherein at least a portion of the optical mask means is disposed between the at least one void and the substrate,
a second voltage applying means configured to apply a voltage value to the second movable reflector means, and
a second cavity defined by a surface of the of the second movable reflector means and a surface of the absorber means.

43. A method of manufacturing an interferometric pixel comprising:
providing a substrate;
forming an optical mask on the substrate;
forming a first movable structure over the substrate, the first movable structure being separated from the substrate by a first distance, the first movable structure comprising a first reflective layer, a first conductive layer, and a first membrane layer disposed between the first reflective layer and the first conductive layer, the first membrane layer having a thickness dimension defined by the distance between the first reflective layer and the first conductive layer;
forming a second movable structure over the substrate, the second movable structure being separated from the substrate by a second distance, the second distance being greater than the first distance, the second movable structure comprising a second reflective layer, a second conductive layer, and a second membrane layer disposed between the second reflective layer and the second conductive layer, the second membrane having a thickness dimension defined by the distance between the second reflective layer and the second conductive layer, the thickness dimension of the second membrane layer being substantially the same as the thickness of the first membrane layer; and
forming at least one void in the second movable structure such that optical mask is positioned between the at least one void and the substrate.

44. The method of claim 43, wherein the optical mask is positioned between at least a portion of the first movable structure and the substrate.

45. A method of manufacturing an interferometric pixel comprising:
providing a substrate having a coefficient of thermal expansion characteristic;
forming an optical mask on the substrate; and
forming a first movable structure over the substrate, the first movable structure being separated from the substrate by a first distance, the first movable structure comprising a first reflective layer having a thickness dimension, a first conductive layer having a thickness dimension, and a first membrane layer disposed between the first reflective layer and the first conductive layer, the first membrane layer having a thickness dimension defined by the distance between the first reflective layer and the first conductive layer, the first movable structure having an effective coefficient of thermal expansion characteristic, wherein the thickness dimension of the first reflective layer, the thickness dimension of the first conductive layer, and the thickness dimension of the first membrane layer are all selected such that the effective coefficient of thermal expansion characteristic of the first movable structure is substantially the same as the coefficient of thermal expansion characteristic of the substrate.

46. The method of claim 45, further comprising:
forming a second movable structure over the substrate, the second movable structure being separated from the substrate by a second distance, the second distance being greater than the first distance, the second movable structure comprising a second reflective layer having a thickness dimension, a second conductive layer having a thickness dimension, and a second membrane layer disposed between the second reflective layer and the second conductive layer, the second membrane layer having a thickness dimension defined by the distance between the second reflective layer and the second conductive layer, the second movable structure having an effective coefficient of thermal expansion characteristic, wherein the thickness dimension of the second reflective layer, the thickness dimension of the second conductive layer, and the thickness dimension of the second membrane layer are all selected such that the effective coefficient of thermal expansion characteristic of the second movable structure is substantially the same as the coefficient of thermal expansion characteristic of the substrate; and
forming at least one void in the second movable structure such that the optical mask is positioned in between the at least one void and the substrate.
